(19) United States
(12) Patent Application Publication
(10) Pub. No.: US 2002/0055088 A1
(43) Pub. Date: May 9, 2002

(54) TOGGLE-TONGUE LANGUAGE EDUCATION METHOD AND APPARATUS

(76) Inventor: EPHRAIM FEIG, CHAPPAGUA, NY (US)

Correspondence Address: IBM CORP, INTELLECTUAL PROPERTY LAW DEPT, P O BOX 218, YORKTOWN HEIGHTS, NY, 10598

(21) Appl. No.: 09/103,766

(22) Filed: Jun. 24, 1998

Related U.S. Application Data
(60) Provisional application No. 60/050,774, filed on Jun. 25, 1997.

(51) Int. Cl. G09B 19/04

(52) U.S. Cl. 434/185

(57) ABSTRACT

A language teaching device utilizes video with audio components of several languages, typically two. The various characters in the video can speak in the several languages. Using simple point-and-click technology, a user can have each of the various characters speak in any of the several languages, enabling arbitrary combination of character-language pairs.

This application claims priority from Provisional Application Ser. No. 60/050,774 which was filed Jun. 25, 1997.

### FIELD OF THE INVENTION

A language teaching device that utilizes video with audio components of several languages.

### BACKGROUND

Multimedia language learning material existed for a long time in the form of audio tapes with accompanying text. The audio included words, phrases, sentences and conversations spoken in both a familiar language and the new language which the student wanted to learn. The process of rewinding for replay was rather tedious. The advent of multimedia delivery via CD-ROM and computers made random access more convenient. It also provided graphic and video accompaniment to the audio to enhance the learning experience. Berlitz, Hyperglot and Random House are three publishers of CD-ROM based language learning material. Typically the contents of the CD-ROM include several scenes (such as at the airport, shopping for food, eating out) each containing a conversation among several people. Sentences can be played in either language; the decision is made by the user by clicking with a mouse on a language menu. The user can select conversation mode-which will play the entire conversation, or sentence mode, which will play individual sentences which the user selects, or even word mode, which will let the user hear individual words.

Common to all these methods is a look-and-feel of a language learning device, which is not at all the same as that of a movie-watching or cartoon-watching experience. For example, children are frequently quickly bored by these programs, while they are typically glued to their televisions when watching cartoons.

Hypermedia is a term used to describe the fusion of two other new technologies: multimedia and hypertext. Multimedia refers to information forms containing text, images, graphics, audio and video. A hypertext document is one which is linked to other documents via hyperlinks. A hyperlink often appears in a hypertext document as a piece of highlighted text. The text is usually a word or phase describing something of which a user might want further information. When the user activates the hyperlink, typically by clicking on it using a mouse, a link command is initiated; which causes a program at the linked address to be executed; which, in turn, causes the user's view to be updated so as to show the linked document, which typically contains more information on the highlighted word or phase concerned. Such information may be in the form of text, audio, video, a two-dimensional image or a three-dimensional image. Hyperlinks make it easy to follow cross-references between documents. Hypermedia documents are hypertext documents with multimedia capabilities. The regions on the screen which are active hyperlinks are called hot-links.

Nowadays, most people are familiar with the application of hypertext by using a mouse to click on hot-links on computer displays of homepages from the World Wide Web (the Web) on the Internet. Data on the Web is located via URLs. URL stands for “Uniform Resource Locator.” It is a draft standard for specifying an object on the Internet. It specifies access method and the location for the files. Documents on the Web are written in a simple “markup language” called HTML, which stands for Hypertext Markup Language. File formats of data on the Web are specified as MIME formats; MIME stands for “Multipurpose Internet Mail Extensions.” (Reference: http://www.oac.uci.edu/indiv/ehood/MIME/MIME.html). Examples of file formats on the Web are au (probably the most common audio format), .html (HTML files), .jpg (JPEG encoded images), .mid (Midi music format), mpg (MPEG encoded video), and .ps (postscript files). While presently hypertext technology is most common in text and image media, it is beginning to also appear in animation and video.

Hypervideo is video in which certain regions during certain time intervals are hot, and are linked to either URLs or files which generally reside in some computers. These hot regions typically track well defined objects in the video. Clicking on hot regions in hypervideo can generate responses such as jumping to another time point in the video, or jumping to another video sequence, or causing other changes in the perceived video. For example, one can program the hot object to jump to another audio track while still displaying the same video track. A hypervideo file format, a hypervideo player, and a hypervideo content creation tool are described in the patent application “Method and Apparatus for Integrating Hyperlinks in Video” by Jeane Chen, Ephraim Feig, and Liang-Jie Zhang. U.S. App. Ser. No. (PCT/1B97/0033/filed Apr. 2, 1997) filed on Jun. 16, 1998 the teaching of which is incorporated herein by reference.

NEC Corporation has demonstrated to Newsbytes such a system, named “video hypermedia system,” that will bring the point and click capabilities of hypertext to full motion video. A more detailed description of HyperVideo may be found in the article “NEC's Video Hypertext System”, Newsbytes News Network, Jul. 31, 1995.

HyperCafe is an experimental hypermedia prototype, developed as an illustration of a general hypervideo system. This program places the user in a virtual cafe, composed primarily of digital video clips of actors involved in fictional conversations in the cafe. HyperCafe allows the user to follow different conversations, and offers dynamic opportunities of interaction via temporal, spatio-temporal and textual links to present alternative narratives. A more detailed description of HyperCafe may be found in the article by Nitin “Nick” Mawhney, David Balcom and Ian Smith, “HyperCafe: Narrative and Aesthetic Properties of hypervideo,” Hypertext '96: Seventh ACM Conference on Hypertext (Recipient of the first Engelbart Best Paper Award at Hypertext '96 (Mar. 20, 1996), http://silver.skiles.gatech.edu/gallery/hyper cafe/HT96_Talk/.

VideoActive is an authoring tool for the creation of interactive movies. It uses the HyperVideo technology to identify hot-links in digital video files. The tool allows one to prepare video clips with the hot-link information and then to link them to other types of media. A more detailed description of VideoActive may be found in “HyperVideo Authoring Tool (User Notes)”, http://ephyx.com/, Prerelease version, Feb. 1996.

Progressive Networks, Inc. has included “clickable video maps” in their RealVideo technology. A mouse click on a portion of the video can cause a new video clip to be played, seek within the current clip, or send a URL message. They provide the RealPlayer which enables this interactivity. A more detailed description of RealVideo may be found at Progressive Network, Inc., “RealVideo Technical White Paper”, http://www.realaudio.com/products/realvideo/overview/index.html. MPEG is one of the most popular standards for encoding video data in compressed digital form. It is a set of international standards, endorsed by ISO. MPEG-1 is the standard video encoding for CD-ROM at 1.5 Mbits per second. Typically the bit budget is allocated at approximately 1.2 Mbps for the video component, 0.2 Mbps for the audio, and 0.1 Mbps for overhead information. The data rates are allowed to vary, as is the resolution of the display, but typically it is 352 by 240 pixels, encoded YUV at 4:2:0 format; these terms are explained in (citation).

Audio is also encoded in wav format and stored in files labeled with the suffix wav. Wav audio is not compressed beyond the quantization due to sampling rate and bits per sample. Radio quality audio is typically 22,050 Hz sampled at 8 bit per channel stereo, which give an encoding at data rates of 43 KBps. Reasonable quality speech can be obtained at 11,025 Hz sampling, 8 bit mono, yielding data rates of 11 KBps. MPEG compressed audio is typically derived from 44,100 Hz sampling stereo at 16 bit per sample.

ActiveMovie is Microsoft software which provides a framework for multimedia computing. It comes with certain built in functions, called filters. These include an asynchronous source input filter for getting data from storage sources; a splitter for taking an MPEG system data stream and splitting its audio and video portions; an MPEG video decoder; an MPEG audio decoder; a video renderer for displaying the video on a computer monitor; an audio renderer for outputting audio to speakers. These filters can be linked to yield an MPEG player. ActiveMovie provides synchronization functionality, which utilizes the time stamps encoded in the audio and video data streams to synchronize their playback. These time stamps are available for further processing, if necessary. For example, random seek procedures utilize these time stamps. One can write ActiveMovie filters which are not included by Microsoft. One such filter is an audio mixer, which takes to audio sources and mixes them. [citation for ActiveMovie].

### BRIEF DESCRIPTION OF DRAWINGS

Further objects, features, and advantages of the present invention will become apparent from a consideration of the following detailed description of the invention when read in conjunction with the drawing FIGS. , in which:

FIG. 1 schematically shows a computer processing system as may be utilized according to the present invention.

FIGS. 2(A) and (B) illustrate the format of an MPEG encoded video file.

FIG. 3 schematically shows a player which is a program which typically resides in a multimedia computer.

FIG. 4 is an example of a flow chart for the player of FIG. 3.

FIG. 5 is an example of a flow chart of another player according to the present invention.

### SUMMARY

A language teaching device, typically a multimedia computer with a CD-ROM containing the language teaching content, utilizes video with audio components of several languages, typically two. The video typically plays in standard pace, such as a movie or a cartoon. Several of the characters are able to speak in any of the several languages. A user can toggle among the various languages for each of the several characters by signaling for such change using standard point-and-click method. This affords the user who is fluent in one of the languages and wishes to learn the second, to follow typical conversations while listening to sentences spoken in a natural setting in the second language.

The player has typical media-player functionalities: play, pause, random seek, reset, and jump to specific locations in the video. The device also has preset toggling menus to accommodate users with varying proficiency levels in the second language. Thus, a beginner level menu will have few of the simpler sentences spoken in the second language, an intermediate level menu may have half the conversation in the second language, while an advanced level menu may have most or all of the conversation in the second language. There is also a random menu generator, with parameters to set at levels between beginner and advanced, which randomly select portions of the conversation to be spoken in the various language. All these features enhance the learning experience by making the process more fun.

### DETAILED DESCRIPTION OF THE INVENTION

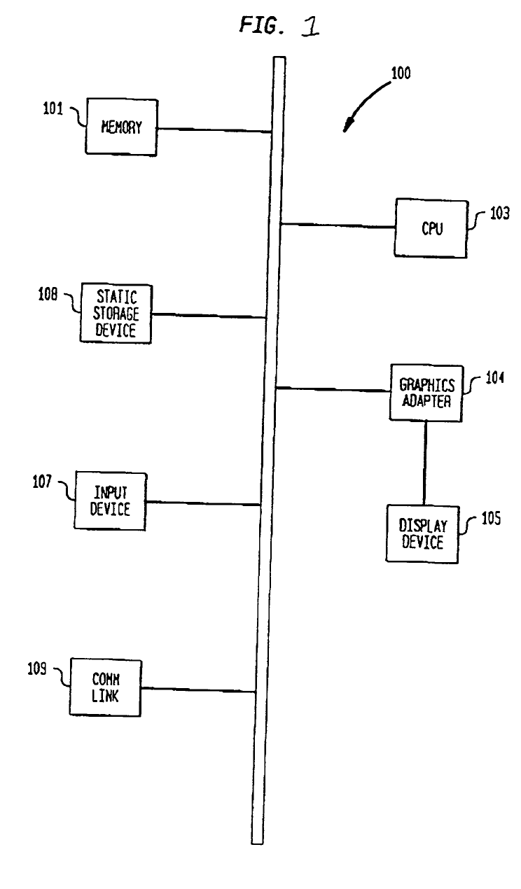

The present invention may be implemented on any computer processing system including, for example, a personal computer or a workstation. As shown in FIG. 1, a computer processing system as may be utilized by the present invention generally comprises memory 101, at least one central processing unit (CPU) 103 (one shown), and at least one user input device 107 (such as a keyboard, mouse, joystick, voice recognition system, or handwriting recognition system). In addition, the computer processing system includes a nonvolatile memory, such as (ROM), and/or other nonvolatile storage devices 108, such as a fixed disk drive, that stores an operating system and one or more application programs that are loaded into the memory 101 and executed by the CPU 103. In the execution of the operating system and application program(s), the CPU may use data stored in the nonvolatile storage device 108 and/or memory 101. In addition, the computer processing system includes a graphics adapter 104 coupled between the CPU 103 and a display device 105 such as a CRT display or LCD display. The application program and/or operating system executed by the CPU 103 generates graphics commands, for example, a command to draw a box (or window), a command to display a bit map image, a command to render a three-dimensional model, or a command to display a video file. Such commands may be handled by the application program/operating system executed by the CPU 103, or by hardware that works in conjunction with the application program/operating system executed by the CPU 103, wherein the appropriate pixel data is generated and the display device 105 is updates accordingly.

In addition, the computer processing system may include a communication link 109 (such as a network adapter, RF link, or modem) coupled to the CPU 103 that allows the CPU 103 to communicate with other computer processing systems over the communication link, for example over the Internet. The CPU 103 may receive portions of the operating system, portions of the application program(s), or portions of the data used by the CPU 103 in executing the operating system and application program(s) over the communication link 109.

It should be noted that the application program(s)/operating system executed by the CPU 103 may perform the methods of the present invention described below. Alternatively, portions or all of the methods described below may be embodied in hardware that works in conjunction with the application program/operating system executed by the CPU 103. In addition, the methods described below may be embodied in a distributed processing system whereby portions of such methods are distributed among two or more processing systems that are linked together via communication link 109.

The present invention presents a new language is a natural movie or cartoon setting. Several of the characters in the movie can speak in two languages, and a user can toggle between them for each of the characters individually. Thus the user can hear conversations in their natural settings with, say, one character speaking one language while the other is speaking the second. It will be appreciated that the user will be able to follow most of the conversation, as this would be the case even had he heard only one of the speakers speaking in a familiar language. The hearing of the second language spoken in context will reinforce the language skill acquisition process. Furthermore, if the underlying material is of interest to the viewer, such as a cartoon is to a child, the viewer will spend more time in this activity thereby increasing the learning experience.

In a preferred embodiment, two characters, char_{—}1 and char_{—}2, can toggle two languages, lang_{—}1 and lang_{—}2. they are called toggling characters. The rest of the characters all speak lang1. A video track is recorded and encoded, preferably using MPEG video compression method. Also four audio tracks are encoded using the MPEG audio encoding. The audio tracks are encoded in the four possible combinations of the two toggling characters speaking the two languages. A playback system is built preferably using Microsoft's ActiveMovie technology. The toggle operation will cause the playback system to choose the appropriate audio track. The time-dependent spatial encoding of the hot regions which activate the toggling are encoded using a modification of the HvMaker hypervideo content creation tool; the latter is described in a previous patent application.

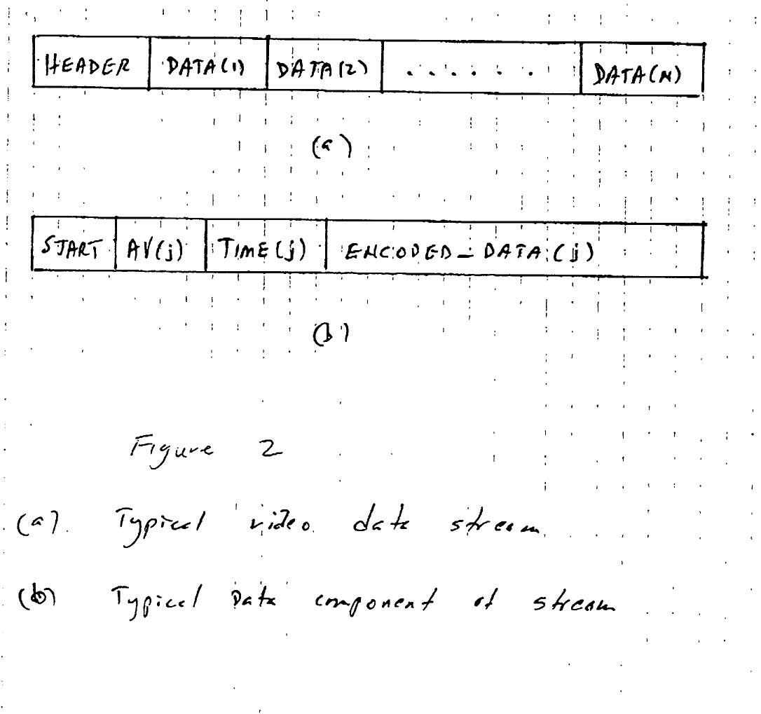

The video files are encoded in any of various standard video formats, such as AVI, MPEG, raw YUV, and raw RGB. For example, Le Gall, Didier J., “MPEG video compression algorithm,” Signal Process Image Commun v 4 n 2 Apr. 1992 p 129-140, (the teaching of which is incorporated herein by reference) describes the MPEG video format. These video formats comprise header information describing some features of the video such as frame rate and file size; encoded pixel values of the color components of the various frames in the video; encoded audio data which synchronously accompanies the video. A frame of video is a single image; video comprises contiguous frames, such that when these are played at a sufficiently high frame rate (typically 25 or 30 frames per second) the result is a visually pleasant motion video. Frames in video are frequently numbered consecutively—frame 1 being the first frame, frame 2 the second, etc. The term frame number refers to the number of a frame in this consecutive ordering. As an example, FIGS. 2(A) and (B) illustrate the format of an MPEG encoded video file. The HEADER contains information such as system clock reference and bit rates for video and audio components. The data packets DATA(j), j=1, 2, . . . , N contain the actual encoded video and audio data. The DATA(j) are described in FIG. 2(B). A special START code signals the start of a new data packet; AV(j) identifies the forthcoming data as either audio or video; TIME(j) gives the timing information necessary to synchronize the video with the audio; ENCODED_DATA(j) are the actual audio or video data. The encoded video data contains information regarding pixel values of color components of frames in the video. In MPEG video, for example, the ENCODED_DATA(j) are binary streams of Huffman encoded run-lengths of quantized DCT coefficients. For a more detailed example see the MPEG standards document, Draft Standard ISO/DIS 11172 (International ISO/IEC JTC 1), herein incorporated by reference in its entirety.

There is an audio track recorded in MPEG format, which captures the entire audio for the presentation except for the audio produced by the two toggling characters. It is called the main audio track. The video and main audio tracks are muxed together using the MPEG-1 muxing syntax to produce an MPEG-1 encoded data stream, which is stored as a file called FILE.mpg. The syntax for this data type is specified in the cited standards document.

The voices of the toggling characters are encoded using wav format. Segments of their speech (or singing, or other utterances) are encoded into separate files, one for each of the two languages. These file segments are labeled char_jkm.wav, and correspond to the char_j speaking the m-th segment in using language lang_k. A table TIME(j,k,m) is created, which gives the starting time in the video of the audio segment m of char_j speaking language lang_k and the time duration of this particular audio segment. There is also a state table STATE(j) which defines the state of the system at any particular point in time. STATE(j)=k means that at the particular time the STATE is queried, char_j is speaking lang_k. The state table is initialized to STATE(j)=1 for j=1 and 2.

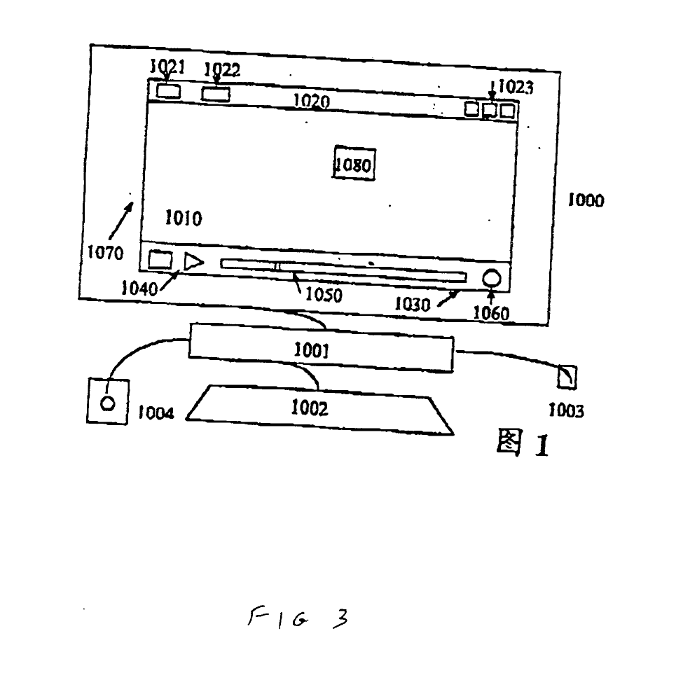

The player is a program which resides in a typical multimedia computer, as pictured in FIG. 3. Specifically, video is being displayed on a computer monitor (1000). This monitor displays data (text, video) which is generated by a computer (1001), to which are also attached a keyboard (1002) and a mouse (1003) in standard configuration. Speakers are attached to the computer. The video is accompanied by audio, as is typical in motion pictures. The computer is also connected in standard fashion to a network connecting device (1004) such as ethernet, token ring or telephone modem, which allows access to the World Wide Web.

The video is contained inside a video display window (1010). The window is bordered in standard fashion, to allow for moving it or resizing it by utilizing the mouse in standard fashion. The top border is a standard panel bar (1020) with an active file button (1021) which, when activated by pointing the cursor at it and clicking with the mouse, displays a menu for initiating actions such as exiting the video program; an active button (1022) which, when activated, displays an options menu; and active buttons (1023) for miniaturizing the display window to an icon on the screen or on a control bar (as in Windows 95), for fast resizing between normal size to full screen size, and for fast termination of the video program. Such button configurations are standard. Underneath the window is a panel bar (1030) which contains active regions (buttons) (1040) for controlling typical video functions as play and stop/pause, and an active slider (1050) for controlling random access to temporal locations in the video. Such configurations are standard in the art.

The present embodiment uses Microsoft's ActiveMovie framework to create the decoders, mixers and renders. FILE.mpg is the stored MPEG-1 encoded data, comprising the video and main audio tracks of the program; SEGS(j,k) are the collections of all audio segments of toggling characters char_j speaking languages lang_k. In this particular implementation, these all reside as files in a file directory with a name which the application identifies as that which contains the video and audio files necessary for its execution; this directory of files resides on a CD-ROM. The entries of SEGS(j,k) are stored contiguously in order according to the time table TIME(j,k,m), so that if TIME(j,k,m) is less than TIME (j,k,n) then the file char_jkm.wave is stored in front of char_jkn.wav. This is done so that when the player has to search for a wav file to play at a particular point in time, the search can proceed efficiently.

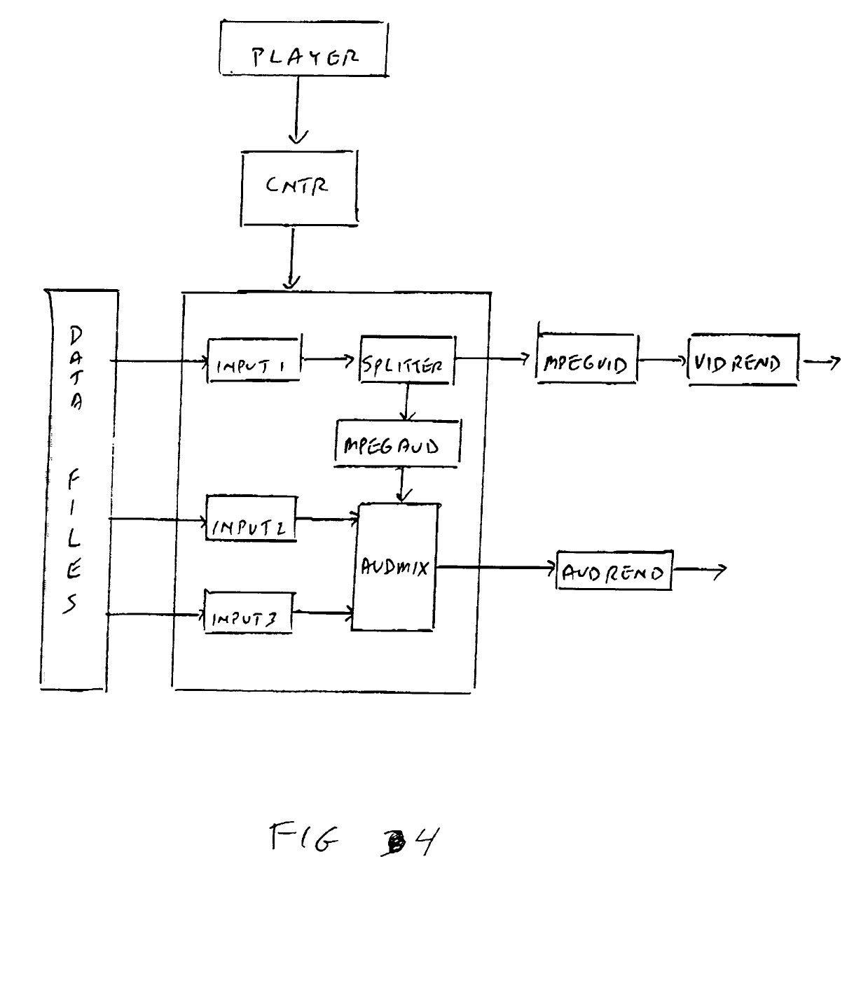

FIG. 4 presents the flowchart for the player. CNTR is the main control unit for the player. A user first selects the appropriate files using standard Windows methods, and then signals to start playing the video, by clicking on the PLAY button on the player GUI. The application finds the appropriate files as they all reside in a directory with a name which is known to the application. This sends a message to CNTR to signal to the CPU to start sending FILE.mpg to INPUTI, an ActiveMovie asynchronous file input filter. INPUT I links to SPLITTER, the ActiveMovie splitter filter. The video output of SPLITTER is linked to MPEGVID, the ActiveMovie MPEG video decoder; the audio output of SPLITTER is linked to MPEGAUD, the ActiveMovie MPEG audio decoder. MPEGVID is linked to VIDREND, the ActiveMovie video renderer. It also sends video time stamps to CNTR.

An ActiveMovie filter AUDMIX is created, which mixes two or three audio sources. One input to AUDMIX is the output of MPEGAUD. The other inputs are from asynchronous input filters INPUT2 and INPUT3, which, in turn, get their inputs various segments SEGS(j,k) from the CR-ROM. The timing for the input of the SEGS(j,k) is controlled by CNTR, which keeps track of the time in the video, and keeps the time synchronized with the time stamps encoded in the MPEG data stream. Every t seconds, CNTR checks with STATE(j) to determine which of the two languages each of the toggling characters should be presently speaking and also scans the TIME(j,k,m) table and determines which segments SEG(j,k) are next due to be played out (other segments may be presently playing), and determines if they will start playing within t seconds. The parameter t is adjustable; in this embodiment t=1.

If CNTR determines that char_jkm.wav will start playing within t seconds, it computes when it should start playing, and when its clock reaches that time, it checks it INPUT2 is busy. If not, it instructs INPUT2 to get char_jkr.wav from the CD-ROM; if yes, it instructs INPUT3 to get char_jkm.wav from the CD-ROM. The ActiveMovie filter graph then performs all the mixing and rendering to display the video with the languages chosen for the toggling speakers.

The actual toggling is done in one of several ways, which all share a common feature. A signal is generated from either the user of from a control function reading a preset toggling timing file or reading the output of a random number generator acting with some preset probabilities and constraints. This signal is transmitted to CNTR, which determines which one of the toggling characters will change language at the start of the playing of its next char_jkm.wav segment.

In one embodiment, two F-keys are set each to toggle one of the toggling characters when clicked. In a second embodiment, the images of the characters themselves are made hot, using the hypervideo technique discussed in the patent application “Method and Apparatus for Integrating Hyperlinks in Video” by J. Chen, E. Feig, and L.J. Zhang. It is noted that this second embodiment makes the program particularly attractive to children who will enjoy clicking on the toggling characters and observing their responses, thereby enhancing their learning experience. When the viewer clicks on one of the toggling characters, its language changes at the next point in time which calls for its next audio segment.

An alternate embodiment for a toggle-tongue player with N toggling characters speaking two languages is given next. Video is encoded using the MPEG-1 video compression standard, and stored as the file V_NAME.mpv. 2^{N} distinct audio tracks are encoded using the MPEG audio encoding standard, each track corresponding to one of the 2^{N} possible combinations of toggling characters speaking the different languages. These are stored as the files A_NAME_K.mpa, where K=L1+2*L2+4*L3+ . . . +2^{(N-1})*L. The integer K ranges over all integers between 0 and 2^{N}−1; the files A_NAME_K.mpa are, correspondingly, all the audio files corresponding to the 2^{N} combinations of language mixings. The file V_NAME_mpv and all the files A_NAME_K.mpa are all stored in a single directory. There is a state table STATE(L1, . . . , LN), where the entries LJ for J=1, . . . ,N are entries 0 or 1, LJ=0 denoting that toggling character J is speaking language 1 and LJ=1 denoting that toggling character J is speaking language 2. When the player is first invoked, the STATE table is initialized so that all entries are 0.

As in the previous embodiment, the player is a program which resides in a typical multimedia computer, as pictured in FIG. 3; details of the figure have been described above.

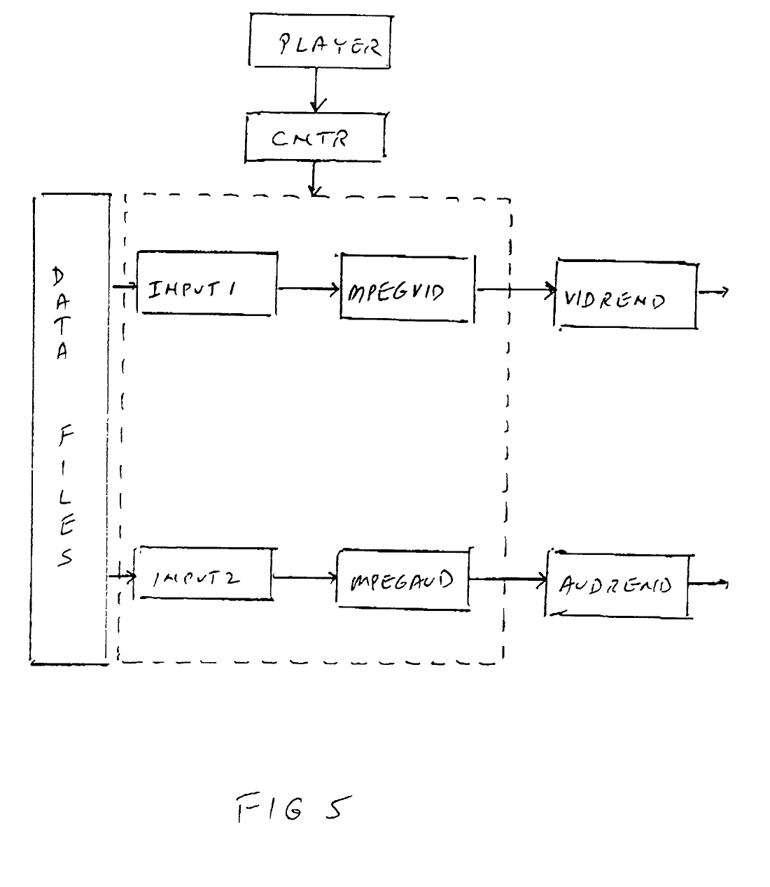

FIG. 5 presents the flowchart for the player in the alternate embodiment. A user first selects the appropriate toggle-tongue files using standard Windows methods, and then signals to start playing the video, by clicking on the PLAY button on the player GUI. This sends a message to CNTR to signal to the CPU to start sending MPV.mpv to INPUT1, an ActiveMovie asynchronous file input filter, and to start sending A_NAME_{—}0.mpa to INPUT2, a second ActiveMovie asynchronous file input filter. INPUTI links to MPEGVID, the ActiveMovie MPEG video decoder, and INPUT2 links to MPEGAUD, the ActiveMovie MPEG audio decoder. MPEGVID is linked to VIDREND, the ActiveMovie video renderer, and MPEGAUD is linked to AUDREND, the ActiveMovie audio renderer. CNTR is linked to INPUT1, INPUT2, MPEGVID, MPEGAUD and the user controlled Windows application. At any time during the video playback, when the user clicks on any of the toggling characters, CNTR determines which of the N characters has been toggled, anb changes the STATE table by toggling the corresponding bit. It then determines which of the 2^{N} audio files INPUT should obtain from the audio files in the directory containing the audio files. It also determined from the time stamps in the video and audio files passing through MPEGVID and MPEGAUD, respectively, how to synchronize the audio and video.

For both embodiments, the actual toggling is done in one of several ways, which all share a common feature. A signal is generated from either the user of from a control function reading a preset toggling timing file or reading the output of a random number generator acting with some preset probabilities and constraints. This signal is transmitted to CNTR, which determines which one of the toggling characters will change language at the start of the playing of its next char_jkm.wav segment.

In one embodiment, two F-keys are set each to toggle one of the toggling characters when clicked. In a second embodiment, regions in the video display window which enclose toggling characters, while they enclose the toggling characters, are made hot, using the hypervideo technique discussed in the patent application “Method and Apparatus for Integrating Hyperlinks in Video” by J. Chen, E. Feig, and L. J. Zhang. It is noted that this second embodiment makes the program particularly attractive to children who will enjoy clicking on the toggling characters and observing their responses, thereby enhancing their learning experience. When the viewer clicks on one of the toggling characters, its language changes at the next point in time which calls for its next audio segment.

The player also executes the standard media player functions, such as random seek, stop, pause, play, and skip to a next marked location in the video.

While the present invention has been described with respect to preferred embodiments, numerous modifications, changes, and improvements will occur to those skilled in the art without departing from the spirit and scope of the invention.

1. A multi-language video playback device comprising specially encoded audio and video files in which several of the speaking characters speak in several languages.

2. A multi-language video playback device according to claim 1 wherein said device is capable of playback so that the several speakers who can speak in the various languages can each speak in any of the various languages at any particular time point in the video.

3. A multi-language video playback device of claim 1 wherein a viewer can, on the fly, choose which of said several languages a speaking character speaks.

4. A multi-language video playback device of claim 1 wherein the number of said several languages is two and a user can toggle between said two languages using standard computer click-and-point or key-entry techniques.

5. A multi-language video playback device of claim 3 wherein a user can affect a change of language of a particular character by pointing on said character when it appears in the video with a cursor which is navigated using a mouse, and then clicking said mouse.

6. A multi-language video playback device of claim 5 wherein the number of languages is two and a user can toggle between said two languages for each individual speaking character using standard computer click-and-point or key-entry techniques.

7. A multi-language video playback device of claim 1 wherein said audio and video file comprises separate audio tracks encoded corresponding to all allowable combinations of speaking characters and corresponding languages.

8. A multi-language video playback device claim 7 wherein said video track is encoded using the MPEG video encoding standard.

9. A multi-language video playback device of claim 1 further including means for changing said several languages by using one of several predetermined schedules.

10. A multi-language video playback device of claim 9 wherein the number of said several languages is two.

11. A multi-language video playback device of claim 1 wherein the changing of languages is done using a random change-decision program with preset probabilities for each of said several languages.

12. A multi-language video playback device of claim 11 wherein the number of said several languages is two.

13. A multi-language video playback device wherein said audio-video file comprises a video track encoded using the MPEG video encoding standard, a main audio track is encoded using the MPEG audio encoding standard, and the various audio tracks of the toggling characters are encoded as wav file segments.

14. A system comprising:
a display;
an audio output;
at least one figure displayed on said display;
selector for said at least one figure;
said selector selects from at least two states of said at least one figure, one of said at least two states activates an audio output in a first language, another of said at least two states activates an audio output in a second language.

15. A system comprising:
a display;
an audio output;
means for displaying figures on said display;
means for selecting from at least two states of said at least one figure, one of said at least two states activates an audio output in a first language, another of said at least two states activates an audio output in a second language.

16. A system according to claim 14 or 15 wherein there are at least two figures displayed on said display, said at least two figures are selectable to activate audio output in different languages.

17. A multi-language video playback device according to claim 1, further comprising:
a CPU, a memory, a static storage device, an input device, and a graphics adapter, each of which is coupled to a bus;
and a display device coupled to said graphics adapter.
